(19) United States
(12) Patent Application Publication
(10) Pub. No.: US 2019/0369896 A1
(43) Pub. Date: Dec. 5, 2019

(54) LEVERAGING SERVER RESOURCES FOR STORAGE ARRAY PERFORMANCE ENHANCEMENTS

(71) Applicant: DELL PRODUCTS L.P., Round Rock, TX (US)

(72) Inventors: Elie Antoun Jreij, Pflugerville, TX (US); David Thomas Schmidt, Round Rock, TX (US); Arieh Don, Newton, MA (US)

(73) Assignee: DELL PRODUCTS L.P., Round Rock, TX (US)

(21) Appl. No.: 15/994,462

(22) Filed: May 31, 2018

(51) Int. Cl. G06F 3/06; G06F 17/30

(52) U.S. Cl. CPC G06F 3/0641; G06F 17/30156; G06F 17/30283; G06F 3/067

(57) ABSTRACT

A system for storing data is disclosed that includes a server and a de-duplication signature processor configured to operate on the server and to generate a de-duplication signature for a data block. The server is configured to access a storage array over a network and to transmit the de-duplication signature to the storage array, and to receive a response from the storage as a function of the de-duplication signature.

### TECHNICAL FIELD

The present disclosure relates generally to storage array processing, and more specifically to a system and method for distributed de-duplication processing for storage arrays.

### BACKGROUND OF THE INVENTION

Storage arrays are used to store data for a large number of servers. In order to optimize storage space, the data is processed using a de-duplication algorithm to create a de-duplication signature. The signature is then checked against stored signatures, and if it is found then the data does not need to be stored, because it is already stored in the storage array. However, de-duplication signature processing is processor intensive.

### SUMMARY OF THE INVENTION

A system for storing data is disclosed that includes a server and a de-duplication signature processor configured to operate on the server and to generate a de-duplication signature for a data block. The server is configured to access a storage array over a network and to transmit the de-duplication signature to the storage array, and to receive a response from the storage as a function of the de-duplication signature.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for de-duplication processing, in accordance with an example embodiment of the present disclosure;

FIG. 2 is a diagram of an algorithm for de-duplication processing, in accordance with an example embodiment of the present disclosure;

FIG. 3 is a diagram of an algorithm for de-duplication processing with algorithm selection, in accordance with an example embodiment of the present disclosure;

FIG. 4 is a diagram of an algorithm for de-duplication processing with collision detection, in accordance with an example embodiment of the present disclosure; and

FIG. 5 is a diagram of an algorithm for de-duplication processing and data request, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

In current storage methodologies a host can send a write command that causes the data to be written to a storage array (SA). If the SA supports a de-duplication algorithm, the SA applies the de-duplication algorithm on the received data to determine whether the received data was already processed by the SA, such as by determining whether the array already has a de-duplication algorithm signature describing the received data. If the array already has this de-duplication algorithm signature, then the array will register the de-duplication algorithm signature in the written range instead of saving the data. The savings associated with de-duplication algorithm processing are realized because the SA saves the relatively short de-duplication signature to the disk, instead of saving the actual data associated with this signature.

Calculating a de-duplication signature for a data block requires substantial processing resources. In the current paradigm, the SA has to calculate the de-duplication signature for all incoming write data commands from all servers attached to it. When receiving a read command, the SA has to inflate the data (translate from the saved de-duplication signature to the actual full data) and send the full data back to the server.

Server hardware may be less expensive than the total cost of an SA, and it is common for server hardware to be frequently renewed than the SA, because SA upgrades require a large amount of data to be retrieved from a current storage device and transferred to a different storage device, which may require the equipment to be out of service for an extended period of time. For example, when updating server hardware, it is usually only required to shift work to another server node, such as when the server hardware is part of a clustered or virtualized server environment. Dedicated hardware can also be provided to servers to handle increased data processing requirements, such as by upgrading a graphics processor card or other processors, but such hardware upgrades are typically not permissible for sealed SA hardware with high system reliability ratings. Thus, while a user may add GPUs or processors to a server to handle increased calculation requirements, such modifications are typically not an option for an SA.

The present disclosure provides a system and method for allowing de-duplication signatures to be calculated by the server processors, or to revert to the SA if the server and SA are not compatible for de-duplication processing. In particular, the server and SA can send the full data to each other (as today) or communicate using de-duplication signatures, so as to allow GPUs or other processors to be added for calculation of de-duplication signatures, using either hardware or software de-duplication processing.

In one example embodiment, the present disclosure can include a Multi Path Input/Output (MPIO) layer on the host that can read from the SA if it supports the mode of communicating with de-duplication signatures, or that can also function using other supported communications processes with the SA. This functionality can be implemented in hardware, to provide the technical advantage of faster local processing of de-duplication signatures, or in software, to provide the technical advantage of greater flexibility in local de-duplication processing.

The MPIO layer can also be configured to read the de-duplication algorithm name and version that is being used by the SA. If the SA already uses a de-duplication algorithm, the MPIO layer can be configured to adopt it. This embodiment can further result in higher efficiencies if the SA only uses a single de-duplication algorithm, because all distributed de-de-duplication processors can use a centralized de-duplication signature database. If the SA does not use a dedicated de-duplication algorithm, the server and SA can be configured to negotiate the algorithm to be used, such as by allowing the server to query a supported algorithm list from the SA and to select a de-duplication algorithm based on one or more predefined criteria, to provide the technical advantage of optimizing de-duplication algorithm processing at multiple independent servers.

If a new server is configured to use the SA for storage but doesn't support the de-duplication algorithm that is currently used by the SA, the server can default to providing all data for storage and allowing the SA to perform all de-duplication processing. Allowing the SA to perform all de-duplication processing is referred to herein as “legacy processing.”

In another embodiment, the SA can store statistics on the de-duplication rate for each distributed server. The MPIO layer can be configured to read these statistics to identify servers that may benefit from communication of de-duplication signatures. For example, if a server frequently transmits data that requires de-duplication processing, that use indicates that the same data is being repeatedly written to the SA, such that communication using de-duplication signatures could be implemented using that server if it is not presently being implemented, to provide the technical advantage of only implementing distributed de-duplication processing at a server if it would result in an optimal loading of de-duplication processing.

In another example embodiment, when a new write command is being processed to be sent from the server to the SA, the MPIO layer can calculate the de-duplication signature for the data, such as by sending the data to a dedicated GPU for de-duplication signature calculation, or by sending the data to another dedicated processor, or by using CPU resources on the server or in other suitable manners. The algorithm decision can also include a decision on the de-duplication block size. Based on the size of data block to be sent to the SA, multiple de-duplication signatures can be produced. The MPIO layer can send the signature[s] to the SA in a vendor-unique (VU) SCSI write command. The new VU SCSI command can have a header with the number of signatures, the signatures, the full data size, other management data or other suitable data.

In another example embodiment, the SA can check to determine if the received de-duplication signature[s] are recognized. For example, if the SA already processed the data, it will have an associated de-duplication signature for the data. In this example, the SA can use a background process that de-duplicates existing non-de-duplicated data on the array, such as data written by servers that do not support de-duplication. If the SA recognizes the de-duplication signature[s], then it can register the signature as the data for that block range, in a manner similar to how an SA that uses legacy processing to support de-duplication processing registers data that was already seen. If the SA doesn't recognize any of the sent signature[s], it can return a dedicated SCSI check condition to the MPIO layer, which can detect that check condition and re-drive the I/O. For example, the MPIO layer can send a standard write SCSI command and all the data (which has not been processed by a de-duplication algorithm). The SA can receive the data and de-duplicate process it offline or in other suitable manners. Alternatively, the MPIO layer can send a VU SCSI command that includes the write data and the de-duplication signature in the last block, so that the SA does not have to calculate the de-duplication signature later.

If the de-duplication processing rate on the device is low, each VU write command with a de-duplication signature will get rejected and require an additional standard write command. The MPIO layer can continue to poll the servers, in case their de-duplication rate changes in the future.

The MPIO layer can also detect the process names sending the write commands, because many commercial applications use the same process name on multiple operating systems. For example, Oracle uses “RedoLog” and “DBWriter” to name the same process on different operating systems. The MPIO layer can detect the sending application name by knowing the name of the process originating the IO. If that sending application has a good de-duplication rate, the MPIO layer can choose these I/O processes as a good-rate de-duplication I/O without querying the array.

In another embodiment, when a read command is received by the SA, the SA can first determine whether the server has de-duplication processing. If not, the SA can use the legacy process to get the data from the back-end and send to the server. If the data has been processed by the de-duplication algorithm, the SA can get the signature[s] associated with read range, deflate them and send them back to the server. The operation of deflating a de-duplication signature (also called data hydration) is less processor intensive, as the SA has a hash table with the signature pointing to the actual data.

The present disclosure provides a number of technical advantages. One technical advantage is that the servers that are attached to the same SA can experience decreased data storage response times, such as when the servers are performing the de-duplication algorithm processing and using the de-duplication signature to determine whether the data needs to be transmitted to the SA for storage. The MPIO layer on each server can also identify whether a server de-duplication rate is high enough to convert to writing de-duplication signatures rather than the entire data set, which provides the technical advantage of avoiding unnecessary de-duplication processing on the server when the data is not likely to be a duplicate.

Another technical advantage of the present disclosure is that using de-duplication signature verification for writing data reduces the amount of bandwidth needed for saving data. In cases of a server connected to two SAs (such as for host mirroring), where one SA is further away (or even remote), reducing link bandwidth on a write command is important. Usually, read commands are satisfied locally (from the SA closest to the server) but a write command has to be shipped to the two SAs, and distance impacts performance severely unless link bandwidth is reduced, such as by using the present disclosure.

Another technical advantage of the present disclosure is the distribution of de-duplication operations between many servers on the cluster, instead of using one SA to perform all of the de-duplication algorithm processing. In this manner, processor loading on the SA can be significantly reduced, in direct relationship to the number of servers that support de-duplication processing.

Another technical advantage of the present disclosure is automatic detection of I/O sources that are likely to benefit from local de-duplication processing, by querying the name of the process originating the I/O. As discussed, empirical analysis may identify processes that generate a substantial percentage of writes commands for duplicated data sets.

Another technical feature of the present disclosure is that the MPIO layer on the server can send a background task to the SA that includes both the signature and data associated with the signature, to allow the SA to determine whether the server has a matching signature interpretation. A data collision (where the same de-duplication signature is generated for different data sets) is rare, but a random check of matching signatures for data blocks in large sets of data can be used to decrease the odds of inadvertently storing or returning the wrong data.

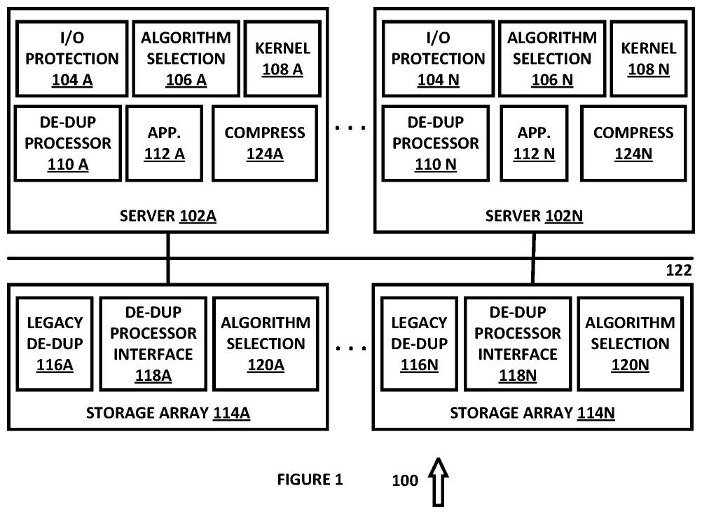

FIG. 1 is a diagram of a system 100 for de-duplication processing, in accordance with an example embodiment of the present disclosure. System 100 includes servers 102A through 102N, I/O protection 104A through 104N, algorithm selection 106A through 106N, kernel 108A through 108N, de-duplication processor 110A through 110N, application 112A through 112N, storage array 114A through 114N, legacy de-duplication 116A through 116N, de-duplication processor interface 118A through 118N, algorithm selection 120A through 120N, network 122 and compression system 124A through 124N, each of which can be implemented in special purpose hardware or special purpose software in combination with special purpose hardware. A person of skill in the art will recognize that a general purpose processor with special purpose software is transformed into a special purpose processor, and that in conjunction with other special purpose hardware such as storage arrays 114A through 114N, that a special purpose system having a special purpose architecture is created that provides the numerous technical advantages discussed herein.

Servers 102A through 102N are general purpose servers with special purpose hardware or special purpose software that transforms general purpose hardware into special purpose hardware in conjunction with special purpose storage arrays. In one example embodiment, servers 102A through 102N can be Dell Poweredge devices or other suitable devices, such as with a suitable graphics processing unit or other supplemental processor for performing de-duplication processing.

I/O protection 104A through 104N are configured to provide input and output protection processing. In one example embodiment, I/O protection 104A through 104N provide standardized path management to optimize I/O paths in physical and virtual environments as well as cloud deployments, optimized load balancing to adjust I/O paths to dynamically rebalance the application environment for peak performance, increased performance to leverage the physical and virtual environment by increasing headroom and scalability and automated failover/recovery by define failover and recovery rules that route application requests to alternative resources in the event of component failures or user errors. In addition, I/O protection 104A through 104N can route data storage output commands to a de-duplication processor such as de-duplication processors 110A through 110N, respectively. In another example embodiment, I/O protection 104A through 104N can route data storage output commands to one or more of de-duplication processors 110A through 110N, such as in response to a load balancing analysis, a load balancing command received from de-duplication processor interface 118A through 118N or other suitable sources, to facilitate optimized de-duplication processing.

Algorithm selection 106A through 106N are configured to coordinate with algorithm selection 120A through 120N to select a de-duplication processing algorithm that is compatible with storage arrays 114A through 114N. In one example embodiment, algorithm selection 106A through 106N can determine whether they are compatible with storage arrays 114A through 114N for de-duplication processing and can utilize a legacy process where storage arrays 114A through 114N perform all de-duplication processing if they are not compatible, and can perform de-duplication processing if they are compatible. In another example embodiment, algorithm selection 106A through 106N can interface with algorithm selection 120A through 120N to identify an optimal algorithm for use in de-duplication processing, such as by using a highest ranked algorithm first if it is available, then a next highest ranked algorithm, and so forth. In another example embodiment, algorithm selection 106A through 106N can interface with algorithm selection 120A through 120N to identify and request an algorithm for use from a remote source for de-duplication processing if a suitable algorithm is not available. Likewise, other suitable processes can also or alternatively be used.

Kernel 108A through 108N provide operating system functionality for servers 102A through 102N, respectively, and are further configured to support the operations of the other components of servers 102A through 102N, respectively.

De-duplication processor 110A through 110N perform de-duplication processing on blocks of data. In one example embodiment, de-duplication processor 110A through 110N can be implemented in hardware and can perform one or more predetermined types of de-duplication processing. In another example embodiment, de-duplication processor 110A through 110N can be programmable and can implement an algorithm provided by algorithm selection 106A through 106N, or other suitable algorithms.

Application 112A through 112N are configured to generate data for storage, and can have data generation properties that make it unlikely that the data has previously been stored. In one example embodiment, when application 112A through 112N generate data for storage, storage array 114A through 114N can track de-duplication processing or can otherwise determine that the data will need both a de-duplication signature and will also need to be transmitted, so as to facilitate distributed de-duplication processing. If application 112A through 112N often generate data for storage that is a duplicate of stored data in storage arrays 114A through 114N, then storage arrays 114A through 114N will need to first determine whether the data associated with a de-duplication signature has been stored, and if so, whether the data should be requested.

Storage array 114A through 114N receive transmitted data for storage from server 102A through 102N, and determine whether the data has previously been stored by comparing a de-duplication signature for the transmitted data and determining whether the de-duplication signature corresponds to previously-stored data. As discussed above, the de-duplication signature processing is processor intensive, and storage array 114A through 114N can receive de-duplication signatures for data from servers 102A through 102N and can compare those de-duplication signatures to saved de-duplication signatures to determine whether it is necessary to request or obtain the associated data for storage. Likewise, other suitable processes can also or alternatively be used to reduce bandwidth, optimize processor loading or otherwise provide technical advantages, as discussed herein.

Legacy de-duplication 116A through 116N provides de-duplication signature processing in accordance with existing procedures, such as to receive data, generate a de-duplication signature and then to determine whether the de-duplication signature matches stored de-duplication signatures. Typically, legacy de-duplication 116A through 116N is selected only when optimized de-duplication processing is not an option for a server, such as when a server is unable to perform the optimized de-duplication processing, when a server is unable to select a de-duplication algorithm that is compatible with storage array 114A through 114N, or in other suitable situations that are dynamically determined.

De-duplication processor interface 118A through 118N are configured to interface with server 102A through 102N to determine whether distributed de-duplication processing can be performed. In one example embodiment, de-duplication processor interface 118A through 118N can determine whether a server has a de-duplication processor, whether algorithm selection is needed, whether legacy processing is needed, whether the statistics for a server can allow a different mode of operation (such as to always or never receive data associated with a de-duplication signature, before or after local de-duplication processing or in other suitable manners), or if other suitable processing as discussed herein is needed or allowable.

Algorithm selection 120A through 120N are configured to coordinate with algorithm selection 106A through 106N to select a de-duplication processing algorithm that is compatible with storage arrays 114A through 114N. In one example embodiment, algorithm selection 120A through 120N can determine whether they are compatible with servers 102A through 102N for de-duplication processing and can utilize a legacy process where storage arrays 114A through 114N perform all de-duplication processing if they are not compatible, and can perform de-duplication processing if they are compatible. In another example embodiment, algorithm selection 120A through 120N can interface with algorithm selection 106A through 106N to identify an optimal algorithm for use in de-duplication processing, such as by using a highest ranked algorithm of algorithm selection 106A through 106N first if it is available, then a next highest ranked algorithm, and so forth. In another example embodiment, algorithm selection 120A through 120N can interface with algorithm selection 106A through 106N to identify and request an algorithm for use from a remote source for de-duplication processing if a suitable algorithm is not available. Likewise, other suitable processes can also or alternatively be used.

Network 122 can be a local area network, a wide area network, a wireless network, a wireline network, an optical network, other suitable networks, a combination of networks or other suitable communications media.

Compression system 124A through 124N can compress data associated with the de-duplication signature processing, such as for storage in storage array 114A through 114N. In one example embodiment, storage array 114A through 114N can compress the data for storage, using processes similar to those used for de-duplication signature processing. For example, if it is determined that the data has already been stored, then compression processing can be bypassed, but if the data has not been stored, then compression processing is performed. Compression system 124A through 124N can perform compression processing in response to data received from storage array 114A through 114N, such as control data generated by de-duplication processor interface 118A through 118N that indicates that the data has not previously been stored, such as from a comparison of a de-duplication signature with stored de-duplication signatures or in other similar manners.

In operation, system 100 is a special configuration system that facilitates the technical advantages of distributed de-duplication processing as discussed herein.

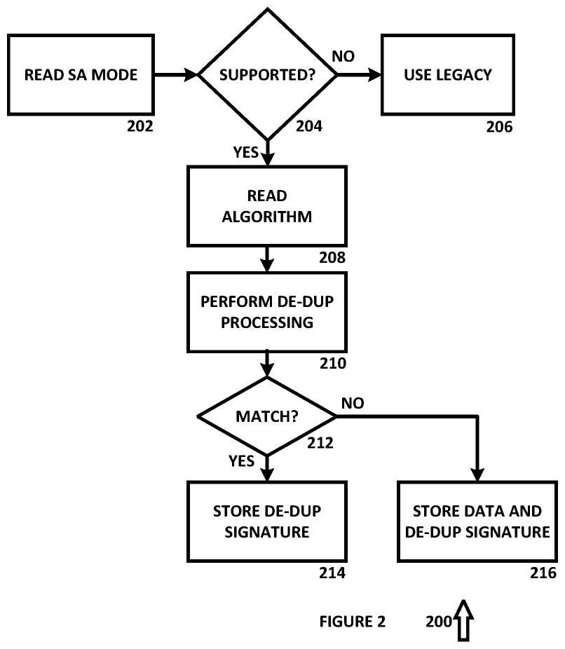

FIG. 2 is a diagram of an algorithm 200 for de-duplication processing, in accordance with an example embodiment of the present disclosure. Algorithm 200 can be used to transform a general purpose computing platform into a special purpose computing platform, and can be implemented in hardware or a suitable combination of hardware and software.

Algorithm 200 begins at 202, where a storage array mode is read or otherwise determined by a server. In one example embodiment, the mode can be read by determining a type or model of storage array, by querying a storage array parameter and comparing the parameter with a predetermined mode identifier, or in other suitable manners. The algorithm then proceeds to 204.

At 204, it is determined whether distributed de-duplication processing is supported. In one example embodiment, determining whether distributed de-duplication processing is supported can be based on server capabilities, storage array capabilities or in other suitable manners. If it is determined that distributed de-duplication processing is not supported, the process proceeds to 206 and legacy de-duplication processing is used, such as by transmitting data to be stored to a storage array and determining at the storage array whether the data has previously been stored, by generating a de-duplication signature and checking to see if that de-duplication signature is already present. Otherwise, the algorithm proceeds to 208.

At 208, a de-duplication algorithm is read. In one example embodiment, the de-duplication algorithm can be read from memory, can be selected based upon storage array parameters, a hardware-implemented algorithm can be selected or used, or other suitable processes can be used. The algorithm then proceeds to 210.

At 210, de-duplication processing is performed, such as on one or more data blocks. In one example embodiment, a de-duplication signature can be generated for each of a plurality of associated blocks of data, blocks of data can be processed in series or other suitable processes can also or alternatively be used. The algorithm then proceeds to 212.

At 212, it is determined whether a match has been identified with a stored de-duplication signature. In one example embodiment, the stored de-duplication signature can be stored at a storage array or in other suitable locations. If it is determined that a match does not exist, then the algorithm proceeds to 216 and the data associated with the de-duplication signature is obtained and stored with the de-duplication signature, such as the original data, compressed data or other suitable data. If uncompressed data is provided, then the storage array can also compress the data. Otherwise, the algorithm proceeds to 214 where the de-duplication signature is stored and associated with the previously stored data.

In operation, algorithm 200 allows de-duplication processing to be distributed to servers or other suitable devices or systems. While algorithm 200 has been shown in flowchart format, object-oriented programming, state diagrams, ladder diagrams or other suitable programming paradigms can also or alternatively be used to implement algorithm 200.

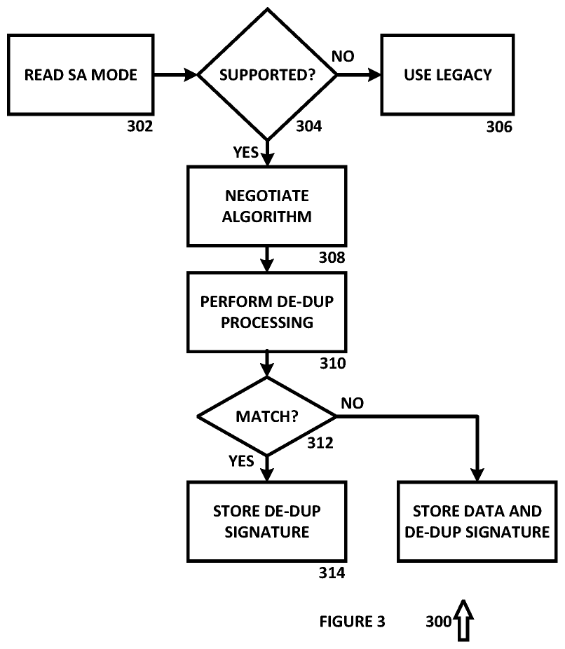

FIG. 3 is a diagram of an algorithm 300 for de-duplication processing with algorithm selection, in accordance with an example embodiment of the present disclosure. Algorithm 300 can be used to transform a general purpose computing platform into a special purpose computing platform, and can be implemented in hardware or a suitable combination of hardware and software.

Algorithm 300 begins at 302, where a storage array mode is read or otherwise determined by a server. In one example embodiment, the mode can be read by determining a type or model of storage array, by querying a storage array parameter and comparing the parameter with a predetermined mode identifier, or in other suitable manners. The algorithm then proceeds to 304.

At 304, it is determined whether distributed de-duplication processing is supported. In one example embodiment, determining whether distributed de-duplication processing is supported can be based on server capabilities, storage array capabilities or in other suitable manners. If it is determined that distributed de-duplication processing is not supported, the process proceeds to 306 and legacy de-duplication processing is used, such as by transmitting data to be stored to a storage array and determining at the storage array whether the data has previously been stored, by generating a de-duplication signature and checking to see if that de-duplication signature is already present. Otherwise, the algorithm proceeds to 308.

At 308, a de-duplication algorithm is negotiated. In one example embodiment, the de-duplication algorithm can be selected in response to a list of available de-duplication algorithms that can be implemented by the storage array, such as to select an algorithm that is most optimal for the server. In another example embodiment, the de-duplication algorithm can be selected as a function of the storage array that the server is associated with, can be selected as a function of the type of data being stored, or other suitable processes can be used. The algorithm then proceeds to 310.

At 310, de-duplication processing is performed, such as on one or more data blocks. In one example embodiment, a de-duplication signature can be generated for each of a plurality of associated blocks of data, blocks of data can be processed in series or other suitable processes can also or alternatively be used. The algorithm then proceeds to 312.

At 312, it is determined whether a match has been identified with a stored de-duplication signature. In one example embodiment, the stored de-duplication signature can be stored at a storage array or in other suitable locations. If it is determined that a match does not exist, then the algorithm proceeds to 316 and the data associated with the de-duplication signature is obtained and stored with the de-duplication signature, such as the original data, compressed data or other suitable data. If uncompressed data is provided, then the storage array can also compress the data. Otherwise, the algorithm proceeds to 314 where the de-duplication signature is stored and associated with the previously stored data.

In operation, algorithm 300 allows de-duplication processing to be distributed to servers or other suitable devices or systems. While algorithm 300 has been shown in flowchart format, object-oriented programming, state diagrams, ladder diagrams or other suitable programming paradigms can also or alternatively be used to implement algorithm 300.

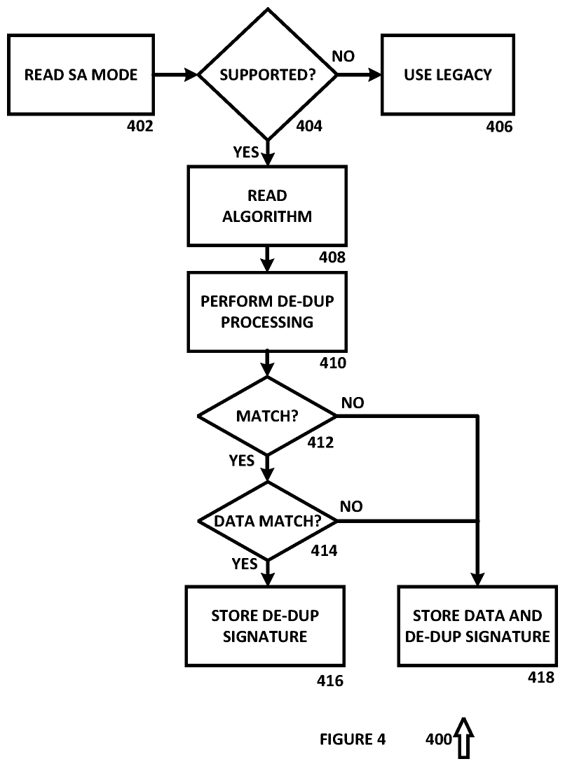

FIG. 4 is a diagram of an algorithm 400 for de-duplication processing with collision detection, in accordance with an example embodiment of the present disclosure. Algorithm 400 can be used to transform a general purpose computing platform into a special purpose computing platform, and can be implemented in hardware or a suitable combination of hardware and software.

Algorithm 400 begins at 402, where a storage array mode is read or otherwise determined by a server. In one example embodiment, the mode can be read by determining a type or model of storage array, by querying a storage array parameter and comparing the parameter with a predetermined mode identifier, or in other suitable manners. The algorithm then proceeds to 404.

At 404, it is determined whether distributed de-duplication processing is supported. In one example embodiment, determining whether distributed de-duplication processing is supported can be based on server capabilities, storage array capabilities or in other suitable manners. If it is determined that distributed de-duplication processing is not supported, the process proceeds to 406 and legacy de-duplication processing is used, such as by transmitting data to be stored to a storage array and determining at the storage array whether the data has previously been stored, by generating a de-duplication signature and checking to see if that de-duplication signature is already present. Otherwise, the algorithm proceeds to 408.

At 408, a de-duplication algorithm is read. In one example embodiment, the de-duplication algorithm can be read from memory, can be selected based upon storage array parameters, a hardware-implemented algorithm can be selected or used, or other suitable processes can be used. The algorithm then proceeds to 410.

At 410, de-duplication processing is performed, such as on one or more data blocks. In one example embodiment, a de-duplication signature can be generated for each of a plurality of associated blocks of data, blocks of data can be processed in series or other suitable processes can also or alternatively be used. The algorithm then proceeds to 412.

At 412, it is determined whether a match has been identified with a stored de-duplication signature. In one example embodiment, the stored de-duplication signature can be stored at a storage array or in other suitable locations. If it is determined that a match does not exist, then the algorithm proceeds to 418 and the data associated with the de-duplication signature is obtained and stored with the de-duplication signature, such as the original data, compressed data or other suitable data. If uncompressed data is provided, then the storage array can also compress the data. Otherwise, the algorithm proceeds to 414.

At 414, it is determined whether a de-duplication signature collision has occurred, such as by comparing a block of data associated with a de-duplication signature with a stored block of data. In one example embodiment, de-duplication signature collision evaluation can be performed on every block of data, on a predetermined selection of data blocks from a larger group of data blocks or other suitable manners. De-duplication signature collision evaluation can also or alternatively be performed at a level of reliability associated with the storage array, such as to provide a predetermined level of data storage reliability. If it is determined that the data being stored does not match the stored data, the algorithm proceeds to 418 where the de-duplication signature is stored in conjunction with the associated data. In another example embodiment, a flag can be stored that indicates that the de-duplication signature is a duplicate of a de-duplication signature for a different set of data, to indicate that additional processing needs to be performed for a read process. For example, the de-duplication signature of the adjacent data blocks can be associated with the de-duplication signature to ensure that the correct data block is retrieved, or other suitable processes can also or alternatively be used. If it is determined that the stored data matches the data associated with the de-duplication signature, the algorithm proceeds to 416 where the de-duplication signature is stored and associated with the previously stored data.

In operation, algorithm 400 allows de-duplication processing to be distributed to servers or other suitable devices or systems. While algorithm 400 has been shown in flowchart format, object-oriented programming, state diagrams, ladder diagrams or other suitable programming paradigms can also or alternatively be used to implement algorithm 400.

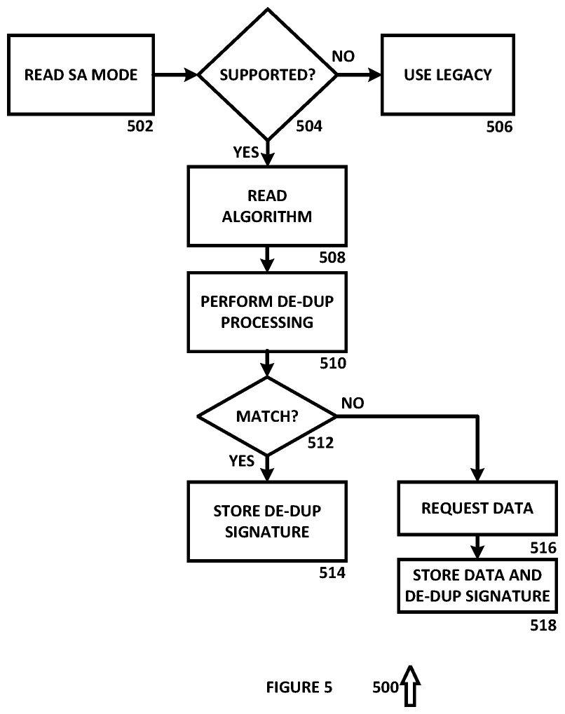

FIG. 5 is a diagram of an algorithm 500 for de-duplication processing and data request, in accordance with an example embodiment of the present disclosure. Algorithm 500 can be used to transform a general purpose computing platform into a special purpose computing platform, and can be implemented in hardware or a suitable combination of hardware and software.

Algorithm 500 begins at 502, where a storage array mode is read or otherwise determined by a server. In one example embodiment, the mode can be read by determining a type or model of storage array, by querying a storage array parameter and comparing the parameter with a predetermined mode identifier, or in other suitable manners. The algorithm then proceeds to 504.

At 504, it is determined whether distributed de-duplication processing is supported. In one example embodiment, determining whether distributed de-duplication processing is supported can be based on server capabilities, storage array capabilities or in other suitable manners. If it is determined that distributed de-duplication processing is not supported, the process proceeds to 506 and legacy de-duplication processing is used, such as by transmitting data to be stored to a storage array and determining at the storage array whether the data has previously been stored, by generating a de-duplication signature and checking to see if that de-duplication signature is already present. Otherwise, the algorithm proceeds to 508.

At 508, a de-duplication algorithm is read. In one example embodiment, the de-duplication algorithm can be read from memory, can be selected based upon storage array parameters, a hardware-implemented algorithm can be selected or used, or other suitable processes can be used. The algorithm then proceeds to 510.

At 510, de-duplication processing is performed, such as on one or more data blocks. In one example embodiment, a de-duplication signature can be generated for each of a plurality of associated blocks of data, blocks of data can be processed in series or other suitable processes can also or alternatively be used. The algorithm then proceeds to 512.

At 512, it is determined whether a match has been identified with a stored de-duplication signature. In one example embodiment, the stored de-duplication signature can be stored at a storage array or in other suitable locations. If it is determined that a match does not exist, then the algorithm proceeds to 516 and the data associated with the de-duplication signature is obtained by requesting the data from the server that performed the de-duplication processing, such as the original data, compressed data or other suitable data. If uncompressed data is provided, then the storage array can also compress the data. The algorithm then proceeds to 518 where the data is stored with the de-duplication signature. Otherwise, if it is determined at 512 that a match exists, the algorithm proceeds to 514 where the de-duplication signature is stored and associated with the previously stored data.

In operation, algorithm 500 allows de-duplication processing to be distributed to servers or other suitable devices or systems. While algorithm 500 has been shown in flowchart format, object-oriented programming, state diagrams, ladder diagrams or other suitable programming paradigms can also or alternatively be used to implement algorithm 500.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for storing data, comprising:
a server;
a de-duplication signature processor configured to operate on the server and to generate a de-duplication signature for a data block; and
wherein the server is configured to access a storage array over a network, to transmit the de-duplication signature to the storage array, and to receive a response from the storage array as a function of the de-duplication signature.

2. The system of claim 1 further comprising a de-duplication interface configured to operate on the storage array and to functionally interact with the de-duplication signature processor.

3. The system of claim 1 further comprising a de-duplication interface configured to operate on the storage array and to provide data identifying a de-duplication algorithm to the de-duplication signature processor.

4. The system of claim 1 further comprising a de-duplication interface configured to operate on the storage array and to receive data identifying a de-duplication algorithm from the de-duplication signature processor.

5. The system of claim 1 further comprising a de-duplication interface configured to operate on the storage array, to receive data identifying an application and to generate responsive control data for the de-duplication signature processor.

6. The system of claim 1 further comprising a de-duplication interface configured to operate on the storage array, to receive data identifying an application and to generate statistics associated with the application.

7. The system of claim 1 further comprising a de-duplication interface configured to operate on the storage array, to receive data identifying an application and to generate responsive control data for the de-duplication signature processor to cause or prevent transmission of data associated with the de-duplication signature.

8. The system of claim 1 further comprising a de-duplication interface configured to operate on the storage array, to receive the de-duplication signature and to compare the de-duplication signature to stored de-duplication signatures.

9. The system of claim 8 wherein the de-duplication interface is configured to receive data associated with the de-duplication signature and to compare the data to stored data to determine whether the de-duplication signature correctly matches one of the stored de-duplication signatures.

10. The system of claim 1 wherein the server further comprises a compression system for compressing data associated with the de-duplication signature and for transmitting the compressed data for storage at the storage array.

11. A method for storing data, comprising:
generating a de-duplication signature for a data block at a server;
transmitting the de-duplication signature to a storage array over a network; and
receiving a response from the storage array as a function of the de-duplication signature.

12. The method of claim 11 further comprising providing data identifying a de-duplication algorithm to the de-duplication signature processor.

13. The method of claim 11 further comprising receiving data identifying a de-duplication algorithm from the de-duplication signature processor at a de-duplication interface configured to operate on the storage array.

14. The method of claim 11 further comprising:
receiving data identifying an application at a de-duplication interface configured to operate on the storage array; and
generating responsive control data for the de-duplication signature processor.

15. The method of claim 11 further comprising:
receiving data identifying an application at a de-duplication interface configured to operate on the storage array; and
generating statistics associated with the application.

16. The method of claim 11 further comprising:
receiving data identifying an application at a de-duplication interface configured to operate on the storage array; and
generating responsive control data for the de-duplication signature processor to cause or prevent transmission of data associated with the de-duplication signature.

17. The method of claim 11 further comprising:
receiving the de-duplication signature at a de-duplication interface configured to operate on the storage array; and
comparing the de-duplication signature to stored de-duplication signatures.

18. The method of claim 17 further comprising:
receiving data associated with the de-duplication signature at the de-duplication interface; and
comparing the data to stored data to determine whether the de-duplication signature correctly matches one of the stored de-duplication signatures.

19. The method of claim 11 further comprising:
compressing data associated with the de-duplication signature at the server; and
transmitting the compressed data for storage at the storage array.
